(19) United States
(12) Patent Application Publication
(10) Pub. No.: US 2006/0250236 A1
(43) Pub. Date: Nov. 9, 2006

(54) Pod-based wireless sensor system

(76) Inventors: Donald E. Ackley, Cardiff, CA (US); Inder-Jeet Gujiral, Newton, MA (US)

Correspondence Address: ROBERT A. PARSONS, 4000 N. CENTRAL AVENUE, SUITE 1220, PHOENIX, AZ, 85012, US

(21) Appl. No.: 11/121,675

(22) Filed: May 4, 2005

(51) Int. Cl. G08B 21/00

(52) U.S. Cl. 340/540

(57) ABSTRACT

A pod-based wireless security system has a plurality of sensor pods with each sensor pod including a plurality of different sensors, a battery pack, a low bandwidth wireless interface, a high bandwidth wireless interface, and a sensor controller. The invention further contemplates a method of using the pod-based wireless security system, which includes providing the plurality of sensor pods, distributing the plurality of sensor pods about an area to be protected, coupling adjacent sensor pods with a low bandwidth wireless protocol and with a high bandwidth wireless protocol through the low bandwidth wireless interface and high bandwidth wireless interface, and using the low bandwidth wireless protocol for routine data transfer and system maintenance and coordination.

### FIELD OF THE INVENTION

This invention relates in general to sensors and sensor systems, such as smoke, burglar, and carbon monoxide sensors or detectors.

### BACKGROUND OF THE INVENTION

Sensor systems are used extensively in homes, offices, factories, and anywhere that people reside or congregate. Generally sensor systems include one or more burglar detectors, smoke detectors, carbon monoxide detectors, etc. Basically, there are two types of sensors that are commercially available. A first type, herein referred to as a portable sensor, is a complete unit in that it includes the sensor and alarm in a single housing, and operates from internal batteries. This portable unit can be placed anywhere in a building and can be moved around if desired but has several problems. First it generally includes only one type of sensor (e.g. fire or heat, smoke, carbon monoxide, etc.) and it only senses the immediate area. Thus, for full protection at least one of these sensors must be placed in every room. Further, several different types (e.g. smoke, carbon monoxide, movement, etc.) may be required in the same area. Second, the batteries have a finite life and must be tested and/or replaced periodically to be sure they are still operable. Third, portable sensors do not communicate with any outside authority, such as police or fire department, but simply sound an alarm that can only be heard in the immediate area. Also, because of the lack of communication, portable sensors are highly subject to false alarms or to miss alarm situations at the edges of their sensory ability.

A second type of sensor system is the well known and popular hard-wired sensor system. The major problem with hard-wired sensor systems is, obviously, the fact that they must be wired into a building. Thus, wires extend from each sensor to a central control panel which becomes costly and unattractive, unless built into the building at the time of initial construction. Further, any changes or updates are very difficult to incorporate since the system is fixed in place by the connecting wires.

It would be highly advantageous, therefore, to remedy the foregoing and other deficiencies inherent in the prior art.

Accordingly, it is an object of the present invention to provide a new and improved pod-based wireless sensor system that is easily installed in virtually any environment.

Another object of the invention is to provide a new and improved pod-based wireless sensor system that is relatively inexpensive to install and operate.

Another object of the invention is to provide a new and improved pod-based wireless sensor system with centralized sensors that improves sensor performance.

Another object of the invention is to provide a new and improved pod-based wireless sensor system that utilizes a multi-protocol wireless interface that improves redundancy and enhances battery life.

Another object of the invention is to provide a new and improved pod-based wireless sensor system that uses battery powered pods to allow optimized sensor placement without requiring proximity to power lines.

Another object of the invention is to provide a new and improved pod-based wireless sensor system containing pods that interact to greatly reduce false alarms and/or missed alarm situations.

Another object of the invention is to provide a new and improved pod-based wireless sensor system, utilizing acoustic sensors, that can operate as an interface with one or more portable detectors, such as smoke detectors and the like.

### SUMMARY OF THE INVENTION

Briefly, to achieve the desired objects of the instant invention in accordance with a preferred embodiment thereof, provided is a pod-based wireless security system having a plurality of sensor pods with each sensor pod including a plurality of different sensors, a battery pack, a low bandwidth wireless interface, a high bandwidth wireless interface, and a sensor controller. The pod-based wireless security system can, alternatively in some applications, include a medium bandwidth wireless interface incorporating the low bandwidth wireless interface and the high bandwidth wireless interface.

The desired objects and purposes of the present invention are further realized in a method of using the pod-based wireless security system, which includes providing the plurality of sensor pods each including a plurality of different sensors, a battery pack, a low bandwidth wireless interface, a high bandwidth wireless interface, and a sensor controller, distributing the plurality of sensor pods about an area to be protected, coupling adjacent sensor pods with a low bandwidth wireless protocol and with a high bandwidth wireless protocol through the low bandwidth wireless interface and high bandwidth wireless interface, and using the low bandwidth wireless protocol for routine data transfer and system maintenance and coordination. The high bandwidth wireless protocol is used in situations requiring large transfers of data, such as to transmit video signals to determine whether an alarm is a real alarm or a false alarm and to couple a master controller and a broadband communications interface to at least one sensor pod.

The desired objects and purposes of the present invention are further realized in a method of using the pod-based wireless security system which includes using a plurality of door and window sensors on the perimeter of the area to be protected, said perimeter sensors being connected to the pod based sensors using the low bandwidth wireless protocol.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings in which:

FIG. 1 is a semi-block diagram illustrating a specific embodiment of a pod-based wireless sensor system in accordance with the present invention; and

FIG. 2 is a simplified block diagram of an embodiment of a multi-sensor pod for use in the pod-based wireless sensor system of FIG. 1.

### DETAILED DESCRIPTION OF THE DRAWINGS

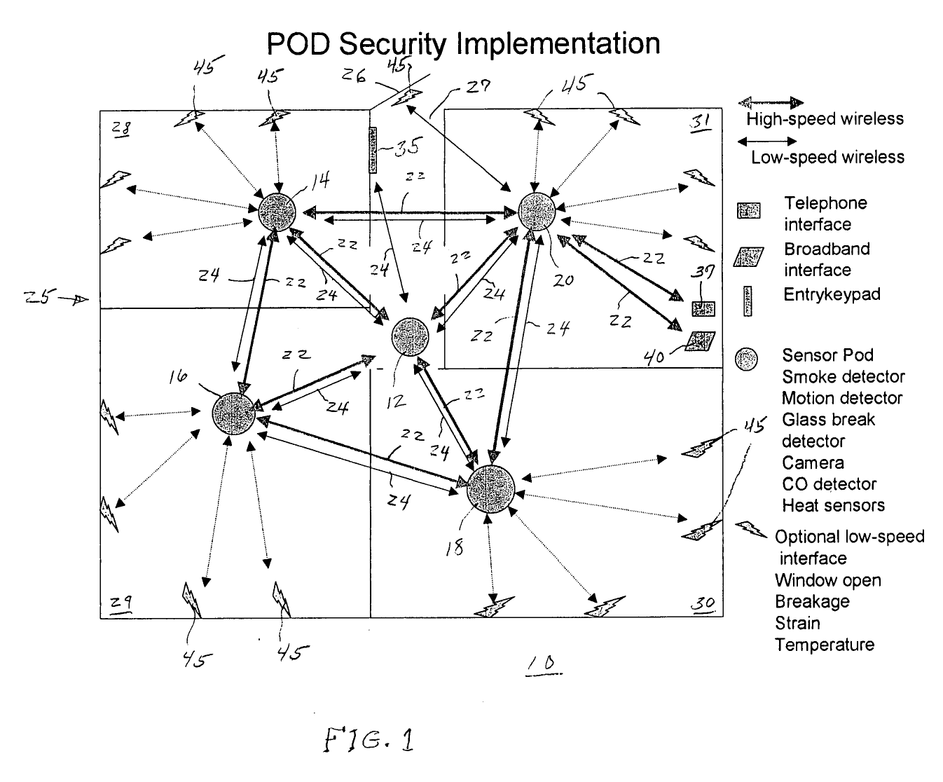

Turning now to the drawings in which like characters designate like parts, attention is first directed to FIG. 1, which illustrates a semi-block diagram of a specific embodiment of a pod-based wireless sensor system 10 in accordance with the present invention. System 10 includes a plurality (in this specific example five) of sensor “pods” 12, 14, 16, 18, and 20 each containing multiple sensors, such as a smoke detector, a motion detector, glass break detector, acoustic sensor, temperature and humidity sensors, a camera, a carbon monoxide detector, heat sensors, and the like.

The various sensor pods 12, 14, 16, 18, and 20 are coupled by a wireless network utilizing multiple wireless protocols or interfaces. As an example of placement for the sensor pods, the outline of a house 25 having a front door 26, an entry hall 27, and four rooms 28, 29, 30 and 31 is illustrated. Further, in this example, sensor pod 12 is placed in entry hall 27, sensor pod 14 is placed in room 28, sensor pod 16 is placed in room 29, sensor pod 18 is placed in room 30, and sensor pod 20 is placed in room 31. It will of course be understood that more or less sensor pods could be utilized with each sensor pod including as many specific sensor types as are deemed necessary, efficient, or useful and the above are included only for example and for purposes of this disclosure. In the preferred embodiment, the pods would be connected in a mesh configuration with the optional sensors connected to the nearest pod using a star topology.

In this preferred embodiment, each of the sensor pods 12, 14, 16, 18, and 20 is coupled to all adjacent pods by a high bandwidth wireless protocol, designated with a wide arrow 22, and by a low bandwidth wireless protocol, designated with a narrow arrow 24. In this embodiment sensor pod 12 is generally centrally located and, in addition to being coupled to each of the other sensor pods by both of the high bandwidth and the low bandwidth protocols, sensor pod 12 is coupled to an entry device 35 adjacent front door 26 by the low bandwidth protocol. Said entry device 35 may be one of a biometric sensor, fingerprint sensor, entry keypad, or keyfob. Sensor pod 20 is coupled to a broadband interface 40 by the high bandwidth protocol and optionally may be coupled to a telephone interface 37 (for purposes to be explained presently) by the high bandwidth protocol. A master controller may be contained in, for example, broadband interface 40, and may be connected to the power lines and have increased information processing power (e.g. a PC or more extensive microprocessor and memory). Also, a plurality of optional external (to the pod sensors) sensors 45 may be distributed around house 25, for example at each window, front door 26, etc. to sense various events, such as open windows or doors, broken windows, acceleration and door or window motion, strain, or significant temperature changes and are coupled to a sensor pod by the low bandwidth protocol.

In an exemplary embodiment, the optional sensors comprise a multi-axis accelerometer which can sense the motion of any door or window to which the sensor is attached. These sensors allow a window or door to be positioned in a partially open position while still allowing the detection of an intrusion by sensing any motion of the door or window.

In another embodiment, the sensor pods contain an acoustic sensor that is specifically intended to sense the warning signals or sirens from conventional portable smoke detectors and other detectors that are not part of the wireless sensor system, for the purpose of activating the wireless sensor system into an alarm state. In this disclosure, battery operated wireless detectors that make noise in response to the detection of an event are referred to generally as “portable detectors” even though they may be permanently placed in some applications.

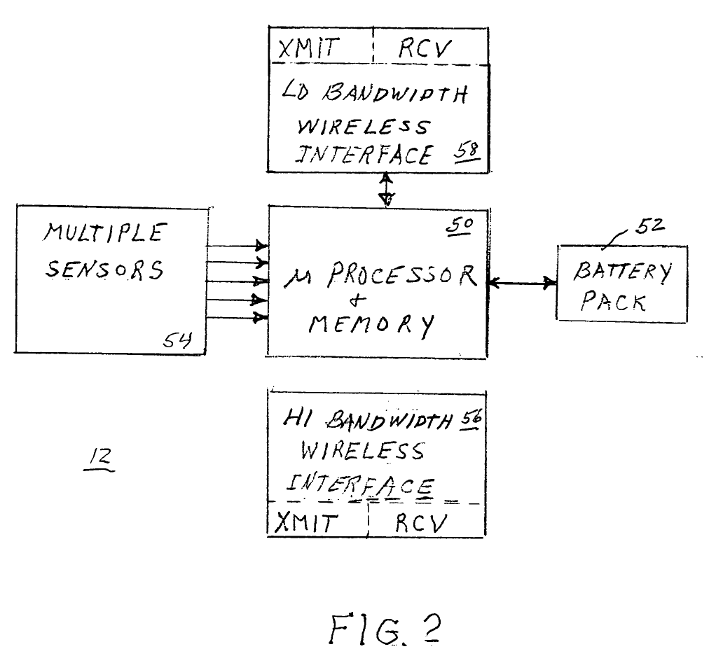

Turning now to FIG. 2, a simplified block diagram is illustrated of a preferred embodiment for a sensor pod, which in this explanation is sensor pod 12, since each of the sensor pods 12, 14, 16, 18, and 20 is identical. In this preferred embodiment, sensor pod 12 includes a simple microprocessor 50 (or other low-power, dedicated sensor controller), a battery pack 52 including one or more batteries for powering sensor pod 12, multiple sensors 54, a high bandwidth wireless interface 56 including the requisite transmitter and receiver, and a low bandwidth wireless interface 58 including the requisite transmitter and receiver. For the wireless interface or controller (i.e. simple microprocessor 50), a single high bandwidth chip and a single low bandwidth chip could be included, possibly sharing a single antenna and circuit board.

Modern digital sensor design reduces power consumption for multiple sensors 54 and a common sensor interface is utilized in each of the sensor pods 12, 14, 16, 18, and 20. The common sensor interface includes, for example, simplified microprocessor 50, or similar device, that controls the various sensors, accumulates information, and controls the transmitter and receiver for each protocol or wireless interface 56 and 58 to send and/or receive information from adjacent sensor pods and to external interfaces (e.g. a broadband interface). Further, microprocessor 50 can be programmed to institute periodic sleep modes in multiple sensors 54 and other battery saving features in the operation. For example, in a specific embodiment, multiple sensors 54 include a smoke detector, a motion detector, an acoustic sensor, a camera, a carbon monoxide detector, and a heat sensor. In this embodiment, the smoke detector, carbon monoxide detector and heat detector might be cycled on for one or two seconds in every one minute interval, the acoustic sensor and the motion detector might be cycled on and off in one second intervals, and the camera might be turned on only when one of the other sensors or sensors in and adjacent sensor pod indicates the occurrence of an event.

The pod-based wireless sensor system 10 incorporating sensor pods 12, 14, 16, 18, and 20 each containing multiple sensors and coupled by a wireless network utilizing multiple wireless protocols is highly desirable for several reasons. One reason is that the number of wireless nodes is minimized. By incorporating multiple sensors into each centralized pod 12, 14, 16, 18, and 20, the number of wireless nodes can be significantly reduced, thereby substantially reducing costs. For example, in a wireless home security network, by eliminating as many door and window sensors as possible and centralizing intruder detection into a pod design, costs can be significantly reduced. In a preferred embodiment the door and window sensors are replaced by motion detectors, cameras, and/or glass break detectors within the sensor pods. However, door and window sensors 45 can optionally be included and coupled to one or more sensor pods 12, 14, 16, 18, and 20 by low speed protocol 58 if the additional protection is desired.

The overall number of batteries or battery packs 52 in pod-based wireless sensor system 10 is reduced, increasing convenience and further reducing costs and improving reliability. Because multiple sensors are concentrated in a sensor pod with a single battery pack (52), power consumption becomes an issue (while the number of batteries in the network as a whole is reduced, the demand on the remaining batteries is increased). Thus, many battery saving techniques are utilized to reduce this demand which, because of microprocessor 50, are relatively easy to incorporate.

Additionally, the complexity of the wireless sensor network is reduced by incorporating multiple sensors in a sensor pod, improving latency and easing software requirements. It will be recognized by those skilled in the art, for example, that sensor pods 12, 14, 16, 18, and 20 can be easily coordinated so that only one sensor pod at a time is transmitting on either the low or high speed protocols. Also, information from multiple sensors 54 can be stored in the memory of microprocessor 50 and transmitted as a single burst rather than transmitting information from multiple individual sensors, one sensor at a time. Further, a single omnidirectional transmission is sufficient to communicate with all other adjacent sensor pods, as opposed to individual directional transmissions from each sensor pod to each of the other sensor pods. Additionally, reliability is significantly enhanced by the multiple paths for signal transmissions between pods.

The concentration of sensor information at each sensor pod 12, 14, 16, 18, and 20 does increase the requirement for bandwidth on the wireless network. Since bandwidth is typically commensurate with increased power consumption, the two protocol system is used in the preferred embodiment to reduce power consumption. Further, since power and bandwidth are directly related, to minimize power consumption the minimum bandwidth possible to achieve the desired connectivity should be utilized. In this configuration, a low-power, low bandwidth protocol such as for example Zigbee (IEEE 802.15) is utilized for routine data transfer and system maintenance and coordination.

These low-power, low bandwidth protocols typically incorporate sophisticated sleep modes into their programming and utilize very low power radios and control chips. Thus it is convenient to wake the system at regular intervals to exchange status information. However, the data rate in a Zigbee system is typically limited to 40 Kb/s (900 MHz) or 250 Kb/s (2.4 GHz). This may be insufficient to transfer sufficient information if all the sensors in a pod are simultaneously in use. For example, in a home security system, upon an alarm delivered by one of the sensors in a sensor pod, it will be important to wake up all the sensors in that pod and/or all the sensors in adjacent sensor pods across the network to determine whether the alarm is real or a false alarm, and furthermore, to evaluate the significance of the alarm state. In addition, to further verify the alarm state, photographic or video information may be utilized. This presumably will require increased bandwidth communication between multiple sensor pods and back to the master controller in broadband interface 40.

A typical high bandwidth system that may be utilized as the high speed wireless protocol is, for example, the IEEE 802.11 protocol. The 802.11 protocol can have bandwidths as large as 55 Mb/s or higher, which is sufficient to transfer even full-frame video data. The 802.11 systems are cheap, secure, readily available, and designed to minimize power consumption as well, although they use significantly more power than the Zigbee protocol. While improvements in power consumption for a wireless network utilizing Bluetooth wireless protocol of around 50% were observed, the Bluetooth wireless protocol still has too much bandwidth (e.g. as high as a approximately 108 Mb/s) and too high power consumption for use in the pod-based sensor network proposed herein if only a single wireless protocol is desirable. So, by using the high bandwidth 802.11 interface only in situations when increased bandwidth is required, the overall power consumption of pod-based wireless sensor system 10 is minimized without compromising performance. While the use of multiple RF protocols can increase system cost, the wireless interfaces are consumer items which are produced in extremely high volumes at extremely low costs.

Here it should be noted that the two interface system (i.e. the low bandwidth and the high bandwidth) might be incorporated or embodied in a single wireless protocol with a bandwidth interface sufficient to convey video efficiently, herein referred to as a “medium bandwidth wireless protocol” for convenience of description. As described above, the Bluetooth wireless protocol has too much bandwidth and too high power consumption for this application. Also, the 802.11 systems, suggested above for the high bandwidth system, use significantly more power than the Zigbee protocol. However, a pod-based wireless sensor system could be provided for some applications in which a medium bandwidth interface sufficient to convey video efficiently but low enough to minimize power consumption might be utilized.

In a typical commercial application of pod-based wireless security system 10, a sensor pod would be placed in every room. A typical sensor pod would contain a smoke detector, motion detector, video camera, and acoustic sensor which would form the basic security system package for fire and intrusion. Each sensor is connected into the pod control circuitry by a standard interface. This will allow the placement of the sensor pods in each room without power cords or wired connections, in locations optimized for sensor performance and aesthetics. Optional sensors within each pod would include glass break detectors, carbon monoxide and heat sensors, humidity sensors, etc. Other optional configurations could include door and window sensors 45 as required, plus flood sensors, which would communicate with a sensor pod 12, 14, 16, 18, or 20 via low bandwidth wireless interface 58. In addition, each sensor pod would contain a low-power, dedicated sensor controller (e.g. a simple microprocessor)

Also, in this commercial application, the system would be programmed using a PC through high bandwidth wireless interface 58. For the wireless interface, a single chip high bandwidth and a single chip low bandwidth interface could be included, possibly sharing a single antenna and circuit board. The availability of the high bandwidth protocol could enable additional functions such as remote video monitoring, elder care, room-to-room tracking, and health-care monitoring, all of which could be included by programming simple microprocessor 50. Additionally, the high bandwidth interface could be used for system software updates, and can enable sensor information processing by a high performance processor pod or a PC connected to the power mains or included in the master controller contained in, for example, broadband interface 40, both for improved sensor performance under an alarm condition as well as for optimization of sensor performance over a long period of time.

Pod-based wireless security system 10 would be connected to the outside world utilizing a broadband internet connection. Pod-based wireless security system 10 could be connected to a cable/DSL modem at broadband interface 40 using high-bandwidth wireless interface 56. In one embodiment, this interface would comprise a wireless or wired USB interface. In yet another embodiment, this interface would be a wired or wireless Ethernet interface. This broadband connection would enable web-base control of the sensor network from any internet enabled computer.

In another embodiment, pod-based wireless security system 10 could be connected to the outside world using a standard telephone connection at telephone interface 37, utilizing a wired or wireless auto-dialer to call selected telephone numbers, for example at a call center. In the commercial application, the telephone connection could comprise a dial-up Internet connection and an IP address. In another embodiment, the telephone connection could simply be a tone recognition system to recognize an alarm code. In a third embodiment, the telephone connection could utilize a voice synthesis apparatus.

Pod-based wireless security system 10 could alternatively, or additionally, be connected to the outside world utilizing cellular phone technology. In this embodiment, a cell phone would be built directly into a sensor pod or an interface unit (e.g. broadband interface 40 or telephone interface 37) that is wired to the power lines. An alarm condition would be communicated by dialing a server farm and utilizing internet protocol to communicate with the server farm. Alternatively, two-way communication could be enabled to allow cell phone control of the sensor network. In a specific embodiment, this control would be achieved using a wireless internet connection on a 2.5 or 3G cell phone.

As part of pod based wireless security system 10 connection to the outside world, automated verification of an alarm state may be achieved through an internet connection to a server farm and associated computer hardware. Specifically, sequential video pictures may be transmitted to the server farm and evaluated for changes that would constitute motion within the field of view of the pod-based camera. Verification could be enhanced using expert system or neural network software at the server farm to enhance reliability of the verification process.

As an additional variant in specific applications, the pod topology could incorporate solar cells or energy scavenging (i.e. vibration or thermal) power sources to power the units during periods of daylight or nighttime use.

Thus, a new and improved pod-based wireless sensor system is disclosed that is easily installed in virtually any environment. The pod-based wireless sensor system is relatively inexpensive to install and operate. Also, the pod-based wireless sensor system centralizes the sensors so that sensor performance is improved and so that the multi-sensor pods interact to greatly reduce false alarms and/or missed alarm situations. Further, the pod-based wireless sensor system utilizes a multi-protocol wireless system that improves redundancy and enhances battery life. The improved use of battery powered pods allows optimized sensor placement without requiring proximity to power lines.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. A pod-based wireless security system comprising a plurality of sensor pods, each sensor pod including a plurality of different sensors, a medium bandwidth interface with bandwidth sufficient to convey video, a sensor controller, and a battery pack, the battery pack connected to energize the plurality of different sensors, the medium bandwidth interface, and the sensor controller, the medium bandwidth interface in each of the sensor pods being coupled to the medium bandwidth interface in at least one other sensor pod of the plurality of sensor pods.

2. A pod-based wireless security system as claimed in claim 1 wherein the medium bandwidth wireless interface includes a low bandwidth wireless interface and a high bandwidth wireless interface.

3. A pod-based wireless security system as claimed in claim 1 wherein the plurality of different sensors in each of the plurality of sensor pods include at least two different sensors from a group including a smoke detector, a carbon monoxide detector, a motion detector, a heat detector, a digital camera, a humidity sensor, and an acoustic sensor.

4. A pod-based wireless security system as claimed in claim 3 wherein the plurality of different sensors in each of the plurality of sensor pods includes an acoustic sensor and the system further includes at least one portable detector with an acoustic alarm for indicating an event positioned within a detecting range of at least one of the acoustic sensors.

5. A pod-based wireless security system as claimed in claim 1 wherein the sensor controller includes a microprocessor.

6. A pod-based wireless security system as claimed in claim 2 wherein the low bandwidth wireless interface includes an omnidirectional low bandwidth transmitter and an omnidirectional low bandwidth receiver.

7. A pod-based wireless security system as claimed in claim 2 wherein the high bandwidth wireless interface includes an omnidirectional high bandwidth transmitter and an omnidirectional high bandwidth receiver.

8. A pod-based wireless security system as claimed in claim 2 wherein the high bandwidth wireless interface includes a multiple antenna high bandwidth transmitter and a multiple antenna high bandwidth receiver.

9. A pod-based wireless security system as claimed in claim 1 wherein the sensor controller in each sensor pod of the plurality of sensor pods is programmed to control at least some of the plurality of different sensors into a periodic sleep mode for battery saving.

10. A pod-based wireless security system as claimed in claim 2 wherein the low bandwidth wireless interface in each sensor pod of the plurality of sensor pods has a bandwidth equal to or less than approximately 250 Kb/s.

11. A pod-based wireless security system as claimed in claim 2 wherein the high bandwidth wireless interface in each sensor pod of the plurality of sensor pods has a bandwidth equal to or less than approximately 55 Mb/s.

12. A pod-based wireless security system as claimed in claim 2 wherein the high bandwidth wireless interface in each sensor pod of the plurality of sensor pods has a bandwidth equal to or less than approximately 108 Mb/s.

13. A pod-based wireless security system as claimed in claim 1 further including at least one multi-axis accelerometer attached to one of a door and a window for sensing movement of the door or window and providing an alarm in response to movement of the door or window, the at least one multi-axis accelerometer being coupled to at least one sensor pod of the plurality of sensor pods by the medium bandwidth interface.

14. A pod-based wireless security system comprising:
a plurality of sensor pods, each sensor pod including a plurality of different sensors, a battery pack, a low bandwidth wireless interface, a high bandwidth wireless interface, and a sensor controller; and
each of the plurality of sensor pods being coupled to adjacent sensor pods in the plurality of sensor pods by a low bandwidth wireless protocol through the low bandwidth wireless interface in the adjacent sensor pods and by a high bandwidth wireless protocol through the high bandwidth wireless interface in the adjacent sensor pods.

15. A pod-based wireless sensor system as claimed in claim 14 further including a master controller coupled to at least one of the plurality of sensor pods by the high bandwidth wireless protocol through the high bandwidth wireless interface in the at least one of the plurality of sensor pods.

16. A pod-based wireless sensor system as claimed in claim 14 further including a telephone interface coupled to at least one of the plurality of sensor pods by the high bandwidth wireless protocol through the high bandwidth wireless interface in the at least one of the plurality of sensor pods.

17. A pod-based wireless sensor system as claimed in claim 14 further including a broadband interface coupled to at least one of the plurality of sensor pods by the high bandwidth wireless protocol through the high bandwidth wireless interface in the at least one of the plurality of sensor pods.

18. A pod-based wireless sensor system as claimed in claim 17 further including a master controller coupled to at least one of the plurality of sensor pods by the high bandwidth wireless protocol through the high bandwidth wireless interface and the low bandwidth wireless protocol through the low bandwidth interface in the at least one of the plurality of sensor pods.

19. A pod-based wireless security system as claimed in claim 14 wherein the plurality of different sensors in each of the plurality of sensor pods include at least two different sensors from a group including a smoke detector, a carbon monoxide detector, a motion detector, a heat detector, a digital camera, a humidity sensor, and an acoustic sensor.

20. A pod-based wireless security system as claimed in claim 14 wherein the sensor controller in each of the plurality of sensor pods includes a microprocessor.

21. A pod-based wireless security system as claimed in claim 14 wherein the low bandwidth wireless interface in each of the plurality of sensor pods includes an omnidirectional low bandwidth transmitter and an omnidirectional low bandwidth receiver.

22. A pod-based wireless security system as claimed in claim 14 wherein the high bandwidth wireless interface in each of the plurality of sensor pods includes an omnidirectional high bandwidth transmitter and an omnidirectional high bandwidth receiver.

23. A pod-based wireless security system as claimed in claim 14 wherein the sensor controller in each sensor pod of the plurality of sensor pods is programmed to control at least some of the plurality of different sensor into a periodic sleep mode for battery saving.

24. A pod-based wireless security system as claimed in claim 14 wherein the low bandwidth wireless interface in each sensor pod of the plurality of sensor pods has a bandwidth equal to or less than approximately 250 Kb/s.

25. A pod-based wireless security system as claimed in claim 14 wherein the high bandwidth wireless interface in each sensor pod of the plurality of sensor pods has a bandwidth equal to or less than approximately 55 Mb/s.

26. A method of using a pod-based wireless security system comprising the steps of:
providing a plurality of sensor pods, each sensor pod including a plurality of different sensors, a battery pack, a low bandwidth wireless interface, a high bandwidth wireless interface, and a sensor controller;
distributing the plurality of sensor pods about an area to be protected;
coupling adjacent sensor pods of the plurality of sensor pods with a low bandwidth wireless protocol and with a high bandwidth wireless protocol through the low bandwidth wireless interface and high bandwidth wireless interface in each of the sensor pods of the plurality of sensor pods; and
using the low bandwidth wireless protocol for routine data transfer and system maintenance and coordination.

27. A method as claimed in claim 26 wherein the step of providing includes providing a master controller and a broadband interface and further including a step of coupling the master controller and the broadband interface to one sensor pod of the plurality of sensor pods with the high bandwidth wireless protocol.

28. A method as claimed in claim 26 including a step of using the high bandwidth wireless protocol to wake up the plurality of different sensors in at least one sensor pod and in adjacent sensor pods to determine whether an alarm is a real alarm or a false alarm.

29. A method as claimed in claim 26 including a step of using the high bandwidth wireless protocol to transmit video data from a plurality of pods to a central server, wherein said video data may be analyzed to determine whether an alarm is a real alarm or a false alarm.

30. The method of claim 29 further including the use of an expert system or neural network to analyze the video data to determine whether an alarm is a real alarm or a false alarm.
